(19) United States
(12) Patent Application Publication
(10) Pub. No.: US 2026/0015276 A1
(43) Pub. Date: Jan. 15, 2026

(54) APPARATUS AND METHOD FOR TREATING BACKWASH SLUDGE FROM HIGH-RATE FILTRATION PROCESS CAPABLE OF RECOVERING CARBON SOURCE

(71) Applicant: BKT CO., LTD., Daejeon (KR)

(72) Inventors: Dae Hwan RHU, Yeoju-si Gyeonggi-do (KR); Jonathan LIBERZON, Long Beach, CA (US); Pronichenko KATYA, Hinman, NH (US); Bong Choe CHOI, Daejeon (KR)

(73) Assignee: BKT CO., LTD., Daejeon (KR)

(21) Appl. No.: 19/337,018

(22) Filed: Sep. 23, 2025

Related U.S. Application Data
(63) Continuation of application No. PCT/KR2024/000321, filed on Jan. 8, 2024.

(30) Foreign Application Priority Data
Apr. 3, 2023 (KR) 10-2023-0043468

(51) Int. Cl. C02F 11/02; C02F 1/00; C02F 11/14

(52) U.S. Cl. CPC C02F 11/02; C02F 11/14; C02F 2001/007; C02F 2209/40; C02F 2209/44; C02F 2301/046

(57) ABSTRACT

A sewage and wastewater treatment apparatus with a backwash sludge treatment system for recovering carbon sources from high-rate filtration backwash sludge is disclosed. The apparatus includes a pretreatment unit for removing grit materials and screenings, a first reactor for settling, thickening, and fermenting the pretreated backwash sludge, a second reactor for receiving and settling sludge from the first reactor and/or pretreatment unit while separating it into settled sludge and supernatant, and a control unit for managing the operation of each component.

### CROSS-REFERENCE TO RELATED APPLICATIONS

This application is a continuation of International Application No. PCT/KR2024/000321 filed on Jan. 8, 2024, which claims priority to Korean Patent Application No. 10-2023-0043468 filed on Apr. 3, 2023, the entire contents of which are herein incorporated by reference.

### TECHNICAL FIELD

The present disclosure relates to an apparatus and method for efficiently treating backwash sludge generated in the backwash process of a high-rate filtration process included in a wastewater and sewage treatment apparatus. In addition, the present disclosure relates to an apparatus for treating backwash sludge, which recovers an organic carbon source from the backwash sludge of a high-rate filtration process for utilization in the effective removal of nitrogen and phosphorus in a bioreactor, and a treatment method using the same.

### BACKGROUND ART

The content described in this section simply provides background information for this embodiment and does not constitute the related art.

Pollutants present in sewage and wastewater include not only solids and organic matter, but also nutrient salts such as nitrogen and phosphorus, and a conventional treatment apparatus for treating such sewage and wastewater is configured to include a primary clarifier 10, a bioreactor 20, and a secondary clarifier 30 as shown in FIG. 1.

The primary clarifier 10 in the wastewater and sewage treatment apparatus 1 is a configuration that removes solids present in sewage and wastewater, and the primary clarifier 10 is performed by gravity-based sedimentation and requires a retention time of about 2 to 3 hours. Conventional gravity sedimentation, as applied in the primary clarifier 10, has a problem in that it requires a large site footprint due to its low surface loading rate and the considerable time needed for sedimentation. Consequently, the installation of auxiliary facilities is required to enhance the treatment speed, which in turn increases maintenance and management costs. Moreover, an additional flow equlaization tank may be required to respond to fluctuations in hydraulic and pollutant loads.

This gravity-based sedimentation method may cause the floatation or washout of settled sludge by reducing the retention time in the clarifier when the influent flow rate increases sharply due to conditions such as rainfall or specific high-flow events. As a result, not only does the treatment efficiency of the clarifier decrease, but the efficiency of the downstream bioreactor is also adversely affected.

Accordingly, attempts have been made recently to replace the primary clarifier 10 using the conventional gravity-based sedimentation method with a high-rate filtration process. The high-rate filtration process can perform primary treatment of pollutants, respond to the inflow of sewage and wastewater exceeding a certain loading rate, reduce site footprint, and improve the treatment speed and efficiency.

Meanwhile, as described above, a nutrient salt such as nitrogen, phosphorus, or the like, which is one of major pollutants in sewage and wastewater, is removed through the bioreactor 20 of a typical wastewater and sewage treatment apparatus 1.

Referring to FIG. 1, the bioreactor 20 for removing phosphorus (P) is configured as a combination of an anaerobic reactor and an aerobic reactor. In order to remove phosphorus (P) in the bioreactor 20, phosphorus-accumulating organisms (PAOs) in the anaerobic reactor convert ATP to ADP, using the released energy to discharge biodegradable soluble phosphorus (PO₄³⁻) and accumulate organic matter. Subsequently, in the aerobic reactor, the microorganisms accumulate more phosphorus in their cells during the process of generating ATP using the energy obtained while oxidizing the accumulated organic matter. The removal of phosphorus is completed while these microorganisms are being separated from the water through solid-liquid separation in the secondary clarifier 30.

In this way, the COD/T-P ratio in sewage and wastewater is very important for the removal of phosphorus (P) in the bioreactor 20. It is generally known that biodegradable dissolved organic matter is contained in sewage and wastewater at approximately 70 to 125 mg/L. However, a higher concentration of dissolved organic matter is required for the stable treatment of phosphorus (P).

In order to secure the content of dissolved organic matter content, the conventional wastewater and sewage treatment apparatus 1 has been equipped with a fermentation tank 40. In this system, the COD/T-P ratio of the bioreactor 20 is satisfied by recovering organic acids, which act as a carbon source, after the acid fermentation of primary sludge from the primary clarifier 10.

Referring to FIG. 1, the fermentation tank 40 included in the conventional wastewater and sewage treatment apparatus 1 receives the primary sludge from the primary clarifier 10 and converts the particulate organic matter components in the sludge into volatile fatty acids (VFAs) and soluble organic matter.

The volatile fatty acids generated in the fermentation tank 40 are recovered in the bioreactor 20 and act as a carbon source, while the remaining sludge is discharged to the anaerobic digester 50 to generate methane gas and perform the sludge treatment.

However, the conventional fermentation tank 40 has a disadvantage in that the fermented and unfermented solids are not properly separated, or solids with poor settleability are often recovered in the bioreactor 20. This results in an increased retention time in the fermentation tank 40.

Meanwhile, the high-rate filtration process has a significant advantage in that high removal efficiency for solids and organic matter can be achieved while shortening the retention time compared to the conventional gravity-based primary clarifier 10. However, this leads to a shortage of the carbon source that can be utilized for the removal of nitrogen and phosphorus in the bioreactor 20. Furthermore, the sludge discharged from the high-rate filtration process is characterized by a low concentration and a short sludge generation cycle due to frequent backwashing, so there is also a problem in that a large amount of backwash sludge is generated. Therefore, the conventional fermentation tank 40 has difficulty in securing sufficient retention time to treat this large amount of backwash sludge and to recover the carbon source contained therein.

### SUMMARY

### Technical Problem

One embodiment of the present disclosure is directed to providing a wastewater and sewage treatment apparatus employing a high-rate filtration process, which can respond to fluctuations in the influent load of sewage and wastewater and minimize the required site footprint, thereby resolving the problems of conventional primary clarifier by gravity-based sedimentation. As a result, this apparatus can treat backwash sludge generated from the high-rate filtration process—characterized by low concentration and high flow rate—without a separate clarifier, while maintaining solids removal efficiency and enabling the stable removal of nitrogen and phosphorus in a bioreactor.

One embodiment of the present disclosure is directed to providing a treatment apparatus that can regulate the generation of organic acids by controlling the flow rate at which backwash sludge generated in the high-rate filtration process flows into and is discharged from a fermentation reactor. The phosphorus (P) removal performance and sludge reduction efficiency of the wastewater and sewage treatment apparatus can be improved by regulating the generation of organic acids.

Furthermore, one embodiment of the present disclosure is directed to providing a treatment apparatus and treatment method capable of efficiently treating backwash sludge by controlling the operation of the apparatus depending on the influent flow rate to the treatment apparatus, the load of contaminants, and/or the amount of backwash water generated in the high-rate filtration process. Such operational control can improve the treatment efficiency of backwash sludge by recovering a carbon source from the backwash sludge or treating solids in backwash water.

### Technical Solution

According to one aspect of the present disclosure, there is provided an apparatus for treating backwash sludge of a high-rate filtration process, the apparatus including a pretreatment unit for removing grit and screenings from the backwash sludge, a first reactor for settling, thickening, and fermenting the backwash sludge that has passed through the pretreatment unit, a second reactor for receiving sludge discharged from the first reactor and/or the backwash sludge that has passed through the pretreatment unit, and separating it into settled sludge and supernatant via sedimentation, and a control unit for controlling the operation of each component within the backwash sludge treatment apparatus.

According to one aspect of the present disclosure, the control unit is configured to, when the influent flow rate to the backwash sludge treatment apparatus is less than or equal to a predetermined reference flow rate, the fermented sludge discharged from the first reactor after being settled, thickened, and fermented is supplied to the second reactor so that solid-liquid separation is performed.

According to one aspect of the present disclosure, the control unit is configured to return a predetermined ratio of the fermented sludge discharged from the first reactor to the inlet side of the first reactor to combine it with the backwash sludge introduced into the first reactor.

According to one aspect of the present disclosure, the control unit is configured to control the process such that the fermented sludge being transferred to the second reactor is mixed with the supernatant discharged from the first reactor to wash the organic acids of the fermented sludge, and then the mixture is introduced into the second reactor.

According to one aspect of the present disclosure, the mixture of the fermented sludge and the supernatant is introduced into the second reactor after a coagulant has been added.

According to one aspect of the present disclosure, the control unit is configured to control the concentration of organic matter recovered from the fermented sludge by adjusting one or more of the ratio of the flow rate of the backwash sludge that has passed through the pretreatment unit distributed to the first and the second reactors, the solids retention time (SRT) within the first reactor, or the discharge flow rate of the fermented sludge that has completed the fermentation process in the first reactor and is discharged to the second reactor.

According to one aspect of the present disclosure, when the influent flow rate to the backwash sludge treatment apparatus exceeds the predetermined reference flow rate, the control unit is configured to distribute the backwash sludge that has passed through the pretreatment unit to the first and the second reactor at a predetermined ratio, and solid-liquid separation by sedimentation and thickening of the sludge is performed in each reactor.

According to one aspect of the present disclosure, when the influent flow rate to the backwash sludge treatment apparatus exceeds the predetermined reference flow rate, the control unit is configured to control the process such that a coagulant is added to the pre-treated backwash sludge before it is distributed to the reactors.

According to one aspect of the present disclosure, the control unit is configured to control a predetermined distribution ratio of the backwash sludge to each reactor so that the hydraulic retention time of the backwash sludge is maintained equally in both reactors.

According to one aspect of the present disclosure, there is provided a method for treating backwash sludge of a high-rate filtration process, the method comprising the steps of removing grit and screenings from backwash sludge, determining whether the influent flow rate of the backwash sludge exceeds a predetermined reference flow rate or not, settling, thickening, and fermenting the backwash sludge from which the grit and screenings have been removed if the influent flow rate of the backwash sludge is less than or equal to the predetermined reference flow rate, and performing solid-liquid separation on the fermented sludge via sedimentation.

According to one aspect of the present disclosure, when the influent flow rate of the backwash sludge exceeds the predetermined reference flow rate, the method further comprises a step of adding a coagulant to the backwash sludge from which grit and screenings have been removed, and performing solid-liquid separation by settling and thickening the sludge by gravity sedimentation.

### Advantageous Effects

As described above, according to one aspect of the present disclosure, there is an advantage in that by efficiently performing solid-liquid separation on the low-concentration, high-flow rate backwash sludge generated in a high-rate filtration process, while simultaneously recovering a carbon source therefrom, the degradation of treatment efficiency due to a shortage of organic matter in the biological process of the wastewater and sewage treatment apparatus can be prevented.

According to one aspect of the present disclosure, the sludge treatment method can be controlled to fluctuations in the influent load to the wastewater and sewage treatment apparatus and/or the load of backwash sludge from the high-rate filtration process. This control method has an advantage of stably maintaining both the main treatment process of the wastewater and sewage treatment apparatus and the subsequent process of the backwash sludge treatment apparatus.

In addition, the concentration of the carbon source recovered from the fermented sludge can be regulated by controlling the retention time required for the backwash sludge fermentation process. This is advantageous for reducing the amount of sludge discharged after fermentation and can further maximize the digestion efficiency in the anaerobic digestion process for sludge reuse.

### BRIEF DESCRIPTION OF DRAWINGS

FIG. 1 is a process diagram of a wastewater and sewage treatment apparatus including fermentation treatment of primary sludge according to the prior art.

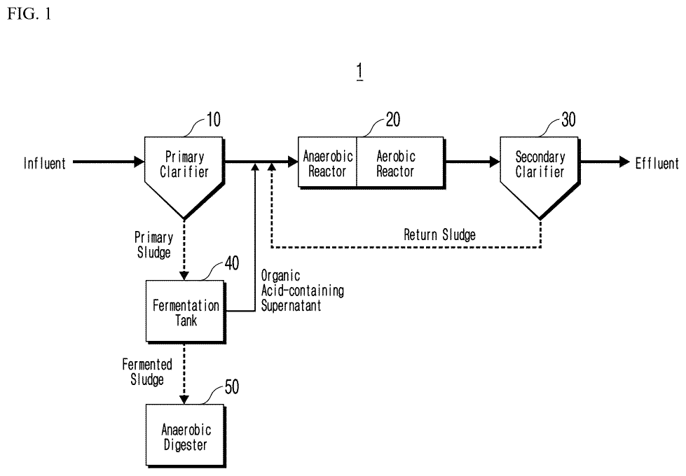

FIG. 2 is a process diagram of a wastewater and sewage treatment apparatus including a backwash sludge treatment apparatus according to one embodiment of the present disclosure.

FIG. 3 is a diagram illustrating the configuration of the backwash sludge treatment apparatus according to one embodiment of the present disclosure.

FIGS. 4A and 4B are diagrams illustrating the first reactor and the second reactor of the backwash sludge treatment apparatus according to one embodiment of the present disclosure.

FIG. 5 is a diagram illustrating an operation in which fermentation treatment of backwash sludge and recovery of carbon source (organic acid) and thickening treatment of backwash sludge are performed simultaneously when the load of backwash sludge introduced into the backwash sludge treatment apparatus is less than or equal to a predetermined reference value, according to one embodiment of the present disclosure.

FIG. 6 is a diagram illustrating an operation in which thickening treatment of backwash sludge is performed when the load of backwash sludge exceeds a predetermined reference value in the backwash sludge treatment apparatus according to one embodiment of the present disclosure.

FIG. 7 is a graph illustrating a correlation between the organic matter concentration required in a bioreactor and the target phosphorus removal amount in the wastewater and sewage treatment apparatus according to one embodiment of the present disclosure.

FIG. 8 is a graph illustrating a relationship between the hydraulic retention time (HRT) for backwash sludge in a fermentation/thickening unit and the target phosphorus removal amount in the backwash sludge treatment apparatus according to one embodiment of the present disclosure.

FIG. 9 is a flow chart illustrating a method for treating backwash sludge in a high-rate filtration apparatus according to one embodiment of the present disclosure.

### DETAILED DESCRIPTION

Since the present disclosure may be modified in various forms and have various embodiments, specific embodiments will be illustrated in the diagrams and described in detail. However, this is not intended to limit the present disclosure to the specific embodiments, and it should be understood that the present disclosure includes all changes, equivalents, and substitutes included in the spirit and technical scope of the present disclosure. While describing each diagram, similar reference numerals are used for similar components.

Terms such as first, second, A, and B may be used in describing various components, but the components should not be limited by the terms. The above terms are used only for the purpose of distinguishing one component from another. For example, a first component may be named a second component, and similarly, the second component may also be named a first component without departing from the scope of the present disclosure. The term “and/or” includes a combination of a plurality of related described items or any one of the plurality of related described items.

When a component is mentioned to be “linked” or “connected” to another component, it may be directly linked to or connected to the other component, but it should be understood that another component may be present in the middle therebetween. Meanwhile, when it is mentioned that a component is “directly linked” or “directly connected” to another component, it should be understood that another component is not present in the middle therebetween.

The terms used in this application are only used to describe specific embodiments and are not intended to limit the present disclosure. Singular expressions include plural expressions unless the context clearly dictates otherwise. In this application, terms such as “include” or “have” should be understood as not precluding the existence or addition possibility of features, numbers, steps, operations, components, parts, or combinations thereof described in the specification.

Unless otherwise defined, all terms used herein, including technical or scientific terms, have the same meaning as generally understood by a person of ordinary skill in the art to which the present disclosure pertains.

Terms such as those defined in commonly used dictionaries should be interpreted as having a meaning consistent with the meaning in the context of the related technology, and unless explicitly defined in this application, should not be interpreted in an ideal or excessively formal sense.

Additionally, each configuration, process, operation, method, or the like included in each embodiment of the present disclosure may be shared within the scope of not being technically contradictory to each other.

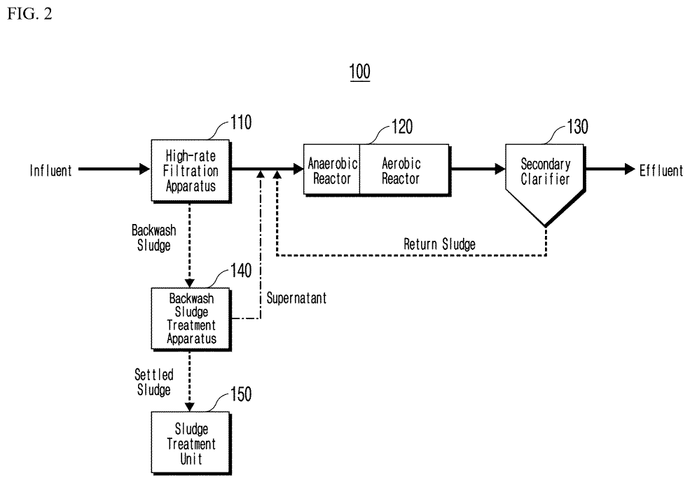

FIG. 2 is a process diagram showing a process of a wastewater and sewage treatment apparatus including a backwash sludge treatment apparatus according to one embodiment of the present disclosure.

As shown in FIG. 2, a wastewater and sewage treatment apparatus 100 including a backwash sludge treatment apparatus according to one embodiment of the present disclosure comprises a high-rate filtration apparatus 110, a bioreactor 120, a secondary clarifier 130, a backwash sludge treatment apparatus 140, and a sludge treatment unit 150.

The wastewater and sewage treatment apparatus 100 removes contaminants such as solids, organic matter, nitrogen, phosphorus, and the like contained in sewage and wastewater by including the components as described above.

The high-rate filtration apparatus 110 initially receives sewage and wastewater, removes solids contained in the sewage and wastewater, and discharges s sewage and wastewater, from which the solids have been removed, to the bioreactor 120.

The high-rate filtration apparatus 110 is a apparatus for removing solids through physical filtration using media. Unlike the conventional gravity-based sedimentation method of the primary clarifier 10, which took several hours, this can shorten the filtration and separation of solids to about 1/10 to 1/20 of the time required. In particular, the high-rate filtration apparatus 110 has an advantage in that a high solid removal efficiency (about 70 to 80%) can be obtained regardless of the settling properties of the solids even with a relatively short retention time (about 5 to 20 minutes).

Accordingly, when treating the same flow rate of the sewage and wastewater, the high-rate filtration apparatus 110 can reduce the required area to 1/10 to 1/20 times that of the primary clarifier 10.

To this end, the high-rate filtration apparatus 110 may include a high-rate filtration unit (not shown), and the influent flow rate may be adjusted for smooth treatment in the bioreactor 120 in the subsequent step.

Solids in sewage and wastewater flowing into the high-rate filtration apparatus 110 are filtered by a filter media packed within the high-rate filtration unit (not shown), and treated water, from which the solids have been filtered, is supplied to the bioreactor 120 to perform subsequent treatment.

For example, the high-rate filtration unit (not shown) of the high-rate filtration apparatus 110 may be configured to include a treated water tank (not shown) for storing treated water from which the solids have been filtered through the filter media, and a backwash water tank (not shown) for collecting backwash water discharged after backwashing the filter media.

Therefore, the treated water from which the solids have been filtered may be temporarily stored in the treated water tank (not shown) and then supplied to the bioreactor 120.

Meanwhile, as the high-rate filtration apparatus 110 progresses in the process of filtering solids, the amount of solids retained within the filter media increases, leading to a rise in head loss. As a result, a process of periodically discharging the solids retained in the filter media must be surely performed.

This process is referred to as backwashing, and when head loss reaches a certain range, filtration is stopped and backwashing is carried out. Solids retained within the filter media are discharged together with backwash water through backwashing, thereby generating backwash sludge. At this time, treated water stored in the treated water tank (not shown) of the high-rate filtration apparatus 110 may be used as backwash water for backwashing.

The backwash sludge generated through backwashing of the high-rate filtration apparatus 110 is temporarily stored in a backwash water tank (not shown) and then discharged to a backwash sludge treatment apparatus 140.

The bioreactor 120 receives the sewage and wastewater from which the solids have been filtered by the high-rate filtration apparatus 110 and performs biological treatment to remove contaminants such as organic matter, nitrogen, and phosphorus contained in sewage and wastewater, and discharges the treated water to the secondary clarifier 130.

For example, the bioreactor 120 may be configured with a combination of reactors such as an anaerobic reactor, an anoxic reactor, and an aerobic reactor. Each reactor may be selectively included in plural units in consideration of the decomposition efficiency of organic matter, the target substances to be removed, and the retention time.

The secondary clarifier 130 receives the treated water from the bioreactor 120 and settles and thickens the solids. The secondary clarifier 130 separates treated water into the excess sludge and supernatant to discharge the supernatant as effluent, and the excess sludge can be returned to the bioreactor 120.

The backwash sludge treatment apparatus 140 receives the backwash sludge discharged after backwashing the filter media from the backwash water tank (not shown) of the high-rate filtration apparatus 110, and performs solid-liquid separation. The separated supernatant is recovered to the inlet side of the bioreactor 120, and the settled sludge is discharged to the sludge treatment unit 150.

The backwash sludge generated from the high-rate filtration apparatus 110, unlike the sludge generated from a conventional gravity-based sedimentation tank, has the characteristics of a low solids concentration and a large volume due to the use of backwash water. The sedimentation sludge from the conventional gravity-based sedimentation tank is discharged at a flow rate of approximately 1 to 2% of the influent flow rate, and has a solid concentration in the range of about 2 to 6% (20,000 to 60,000 mg/L). In contrast, the backwash sludge generated from the high-rate filtration apparatus 110 is produced at a flow rate of about 5 to 15% of the influent flow rate, has a solid concentration range from about 0.1 to 0.5% (1,000 to 5,000 mg/L), and is discharged at a relatively low concentration. Moreover, the flow rate and solids characteristics of the backwash sludge may vary depending on fluctuations in the influent flow rate and pollutant load of the sewage and wastewater flowing into the high-rate filtration apparatus 110.

Accordingly, the backwash sludge treatment apparatus 140 of the present disclosure can selectively control the treatment method of the backwash sludge according to the load of sewage and wastewater flowing into the high-rate filtration apparatus 110 and/or the load of the backwash sludge discharged from the high-rate filtration apparatus 110. The backwash sludge treatment apparatus 140 can also supply a carbon source to the bioreactor 120 in the process of separating the backwash sludge into solids and supernatant, and can further improve the sludge treatment efficiency in the sludge treatment unit 150.

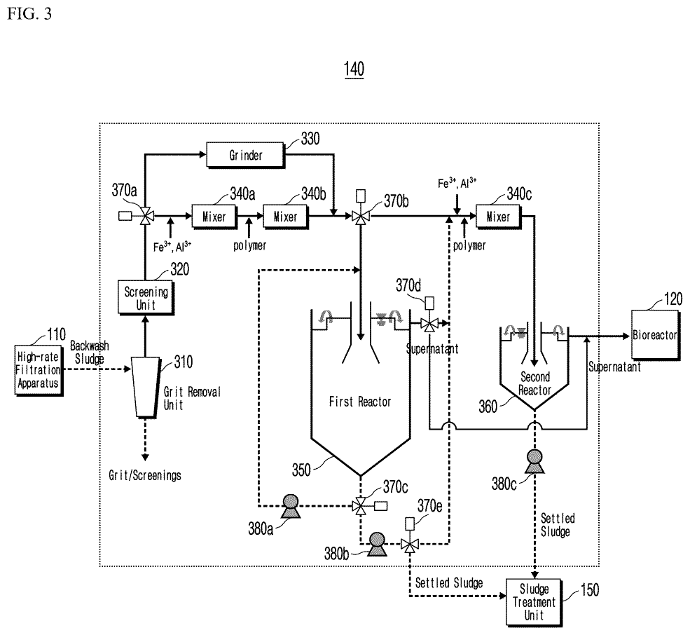

The specific configuration and operation of the backwash sludge treatment apparatus 140 will be described later with reference to FIGS. 3 to 5.

The sludge treatment unit 150 receives the sludge separated from the backwash sludge treatment apparatus 140 to perform subsequent treatment of the sludge.

The sludge treatment unit 150 may employ a dewatering and drying method for landfill disposal of sludge, and an anaerobic digester may be applied to reduce sludge volume and recycle resources by producing methane (CH₄) gas.

FIG. 3 is a diagram illustrating the configuration of the backwash sludge treatment apparatus 140 according to one embodiment of the present disclosure.

Referring to FIG. 3, the backwash sludge treatment apparatus 140 according to one embodiment of the present disclosure comprises a grit removal unit 310, a screening unit 320, a grinder 330, mixers 340a, 340b, and 340c), a first reactor 350, a second reactor 360, flow control valves 370a, 370b, 370c, 370d, and 370e, sludge discharge pumps 380a, 380b, and 380c, and a control unit (not shown).

The grit removal unit 310 receives the backwash sludge discharged from the high-rate filtration apparatus 110, primarily removes grit from the backwash sludge, discharges the removed grit to the outside, and discharges the backwash sludge from which the grit has been removed to the screening unit 320.

As described above, the backwash sludge generated from the high-rate filtration apparatus 110 has a lower concentration and high flow rate compared to the settled sludge generated from the gravity-based sedimentation tank.

In addition, while scum is generated in the gravity-based sedimentation tank due to the floatation of low-specific gravity solids and screenings to the supernatant, the high-rate filtration apparatus 110 minimizes scum generation through physical filtration, enabling stable treated water to be secured. However, grit and screenings contained in the influent sewage and wastewater are rejected by the filter media and end up in the backwash sludge.

As such, backwash sludge containing a large amount of grit and screenings reduces the fermentation efficiency in the first reactor 350 and also affects the anaerobic digestion efficiency in the sludge treatment unit 150. Therefore, for the fermentation treatment of the backwash sludge, high specific gravity grit and screenings with poor settleability must be removed by pretreatment step.

The grit removal unit 310 may be a cyclone device, but the present disclosure is not limited thereto, and any device capable of removing grit from the backwash sludge based on the difference in specific gravity of solids may be applied as the grit removal unit 310.

For example, if the grit removal unit 310 is a cyclone device, the cyclone-type grit removal unit 310 separates grit materials such as sand with a high specific gravity contained in the backwash sludge by using the centrifugal force generated by the swirling flow of the inflowing backwash sludge.

The separated grit materials are collected at the bottom by gravity and a downdraft air current and discharged to the outside, and the backwash sludge from which grit has been separated becomes an upward swirling flow and is discharged to the screening unit 320.

The screening unit 320 receives the backwash sludge from which grit has been removed in the grit removal unit 310, and removes screenings with poor settleability, and discharges the flow to a subsequent process.

Unlike the primary clarifier of the gravity-based sedimentation, the high-rate filtration apparatus 110 effectively removes screenings with poor settleability. As a result, the backwash sludge discharged from the high-rate filtration apparatus 110 contains screenings, and these screenings can deteriorate the water quality of the supernatant recovered to the bioreactor 120.

For example, a drum screen may be applied as the screening unit 320. The screen may be a fine screen or a microfine screen, but the present disclosure is not limited thereto, and the screen may be appropriately selected and used depending on the amount and properties of the screenings.

The backwash sludge from which screenings have been removed in the screening unit 320 is discharged through the flow control valve 370a to the grinder 330 or mixers 340a and 340b.

The grit removal unit 310 and the screening unit 320 correspond to pretreatment unit for treating the backwash sludge, and at least one of the grit removal unit 310 and the screening unit 320 may be included in the backwash sludge treatment apparatus 140.

As described above, the backwash sludge treatment apparatus 140 can select as the backwash sludge treatment method either fermentation and carbon source (organic acid) recovery or sludge thickening treatment depending on the influent load to the high-rate filtration apparatus 110 and/or the load of backwash sludge discharged from the high-rate filtration apparatus 110. Accordingly, the backwash sludge that has passed through the screening unit 320 is directed along a discharge path controlled by a control unit (not shown), and the path can be directed to either the grinder 330 or the mixers 340a and 340b by the flow control valve 370a that is operates in conjunction with the control unit (not shown).

The grinder 330 grinds the backwash sludge that has passed through the screening unit 320 and discharges the pulverized backwash sludge to the first reactor 350.

If fermentation and carbon source recovery treatment are required for the backwash sludge, the grinder 330 receives and processes the backwash sludge under the control of a control unit (not shown). In other words, the grinder 330 is a pretreatment means for improving the fermentation efficiency of the backwash sludge in the first reactor 350.

The fermentation process consists of hydrolysis and fermentation steps, and through this process, biodegradable dissolved organic matter (Readily Biodegradable Soluble COD, Sₛ) mainly composed of volatile fatty acids (VFAs) is recovered as a carbon source.

Process factors that can control the efficiency of the fermentation process include reaction temperature, retention time, and particle size of solids. In general, higher reaction temperature, longer retention time, and the smaller particle size of solids, i.e., higher hydrolysis ratio, can improve the efficiency of acid fermentation.

Since increasing the reaction temperature of the fermentation process requires energy consumption, it acts as a factor in increasing the operating cost of the apparatus. Furthermore, an increase in the retention time also presents a problem, as it either increases the reactor's site footprint or lengthens the treatment time. Therefore, the present disclosure can improve the fermentation efficiency in the first reactor 350 in the subsequent step by reducing the particle size of the sludge for the fermentation reaction using the grinder 330.

The grinder 330 may be a wet grinding type capable of grinding backwash sludge. When the grinder 330 is used to reduce the size of sludge particles, no chemical injection for coagulation is performed.

The mixers 340a and 340b perform mixing backwash sludge after chemical addition that has passed through the screening unit 320 to improve the coagulation and settleability of backwash sludge.

When sludge thickening treatment is required for backwash sludge, the mixers 340a and 340b receive backwash sludge that has passed through the screening unit 320 by a control unit (not shown), treat it, and discharge it into the first reactor 350.

In order to improve the settleability of backwash sludge, as a coagulant, an inorganic coagulant of the Al(III) or Fe(II) series may be primarily injected, and a polymer coagulant may be secondarily added.

The backwash sludge, to which each coagulant has been added, sequentially passes through the two-stage mixers 340a and 340b, where coagulation occurs through floc formation, cross-linking, and adsorption. At this time, a static mixer may be used as the mixers 340a and 340b.

The first reactor 350 receives the backwash sludge that has passed through the grinder 330 or mixers 340a and 340b and performs solid-liquid separation into supernatant and sludge. Then, the separated supernatant is discharged to the second reactor 360 or bioreactor 120, and the settled sludge is discharged to the second reactor 360 or sludge treatment unit 150.

Specifically, when the first reactor 350 receives the backwash sludge that has passed through the grinder 330, it performs the function of a fermentation tank to produce fermented sludge by settling, thickening, and fermenting the incoming sludge. On the other hand, when the backwash sludge that has passed through the mixers 340a and 340b and has formed a floc is received, the first reactor 350 treats the backwash sludge by performing solid-liquid separation into sludge and supernatant through settling and thickening.

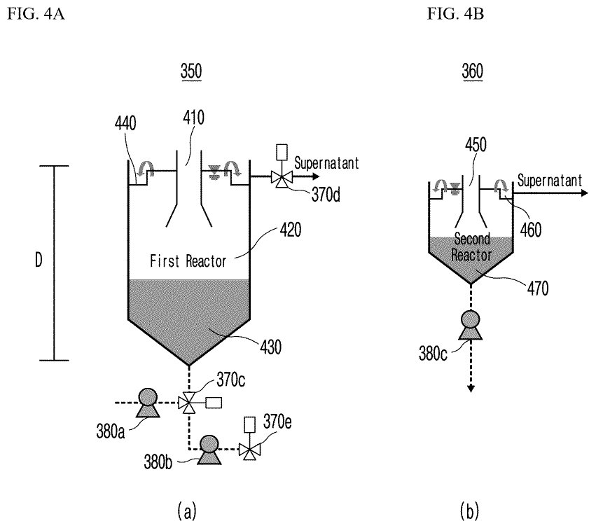

FIGS. 4A and 4B are diagrams illustrating detailed configurations of the first and second reactors 350 and 360 of the backwash sludge treatment apparatus 140 according to one embodiment of the present disclosure.

Referring to FIG. 4A, the first reactor 350 includes an inlet section 410, a solid-liquid separation section 420, a fermentation/thickening section 430, and a supernatant discharge section 440.

The inlet section 410 receives the backwash sludge flowing into the first reactor 350 and supplies it to the inside of the first reactor 350.

The internal space of the first reactor 350 is composed of a solid-liquid separation section 420 and a fermentation/thickening section 430. With respect to the total height (D) of the first reactor 350, the space from the top down to the ⅓ point (⅓D) is composed of a solid-liquid separation section 420, and the remaining space is composed of a fermentation/concentration section 430. The solid-liquid separation section 420 and the fermentation/concentration section 430 are not separated by a physical partition but are zones distinguished by the gravity-based sedimentation of the backwash sludge flowing in.

The backwash water and backwash sludge flown into the inside through the inlet section 410 undergo settling and separation in the solid-liquid separation section 420 by gravity. The sludge settles and sinks to the fermentation/concentration section 430 at the bottom, and the supernatant is discharged to the outside through the supernatant discharge section 440 provided at the top of the first reactor 350.

The supernatant discharge section 440 may be configured with a weir structure, and the supernatant from the solid-liquid separation section 420 may overflow the weir and be discharged to the outside.

The sludge settled in the fermentation/concentration section 430 is subjected to fermentation and/or thickening while being maintained in a settled state in the fermentation/concentration section 430 for a predetermined retention time.

The first reactor 350 does not include a separate internal agitation device, and allows the sludge to go through the processes of sedimentation, thickening, and fermentation while the sludge is moved downward by gravity, and the sludge is discharged in the order in which it has flowed in through a sludge discharge port (not shown) at the bottom.

The first reactor 350 may be formed as a reactor having a circular or rectangular cross-section, but considering the transfer and recovery of sludge, it is preferable to apply a circular reactor. In addition, the fermentation/concentration section 430 of the first reactor 350 is preferably formed in an inverted conical or “V”-shaped structure with a sloped bottom so that the sludge can be smoothly discharged from the bottom.

Referring again to FIG. 3, the backwash sludge flown into the first reactor 350 is separated into supernatant and settled sludge, and the settled sludge is drawn out by sludge discharge pumps 380a and 380b and discharged to either the second reactor 360 or to the sludge treatment unit 150 for subsequent treatment. At this time, a portion of the sludge discharged to the second reactor 360 may be recirculated to the inlet side of the first reactor 350 as needed.

In addition, the supernatant discharged from the first reactor 350 may be mixed with the sludge discharged to the second reactor 360 or discharged to the bioreactor 120 to perform post-treatment.

The discharge and transfer path of the sludge discharged from the first reactor 350 may be regulated by flow control valves 370c and 370e and a sludge discharge pumps 380a and 380b, which are linked to the control unit (not shown). Likewise, the supernatant discharged from the first reactor 350 may also be mixed with the sludge transferred from the first reactor 350 to the second reactor 360 by a flow control valve 370d that is linked by a control unit (not shown) or discharged to the bioreactor 120.

The mixer 340c mixes the mixture of fermented sludge and supernatant discharged from the first reactor 350 and the backwash sludge flowing in directly without passing through the first reactor 350 after adding a coagulant in order to improve the solid-liquid separation efficiency of the sludge.

Coagulant that may be used upstream of the mixer 340c may include one or more of an inorganic coagulant of the Al(III) or Fe(III) series and a polymer coagulant may be selected and used, and a static mixer may be applied as the mixer 340c.

The second reactor 360 receives a mixture of sludge and supernatant with improved coagulation characteristics through a mixer 340c, performs solid-liquid separation by gravity sedimentation, and discharges the settled sludge to a sludge treatment unit 150 and the supernatant to a bioreactor 120, respectively.

Referring to FIG. 4B, the second reactor 360 includes an inlet section 450, a supernatant discharge section 460, and a thickening section 470.

The inlet section 450 receives a mixture of sludge in which a coagulant is added to form a floc, and supernatant, and introduces the mixture into the second reactor 360 so that solid-liquid separation is performed by gravity sedimentation inside the reactor 360.

The second reactor 360 may be formed in the same shape as the first reactor 350. However, in order to perform solid-liquid separation within a short period of time, the second reactor 360 may be formed so that the volume of the second reactor 360 is in a range of ¼ to ½ times the volume of the first reactor 350, and it is more preferable to form it in a volume of ⅓ times the volume of the first reactor 350.

Referring again to FIG. 3, the control unit (not shown) controls the operation of each component in the backwash sludge treatment apparatus 140.

The control unit (not shown) selects the treatment method of the backwash sludge as either fermentation/carbon source recovery or sludge thickening, depending on the load of sewage and wastewater flowing into the high-rate filtration apparatus 110 and/or the load of the backwash sludge discharged from the high-rate filtration apparatus 110. According to the selected treatment method, the control unit (not shown) controls the operation of the flow control valves 370a, 370b, 370c, 370d, and 370e and the sludge discharge pumps 380a, 380b, and 380c so that fermentation and carbon source recovery treatment or sludge thickening treatment may be performed.

For example, the control unit (not shown) can control whether to perform fermentation and carbon source recovery treatment or sludge thickening treatment or not depending on whether the influent flow rate (Q) of the backwash sludge flowing into the backwash sludge treatment apparatus 140 exceeds a predetermined reference value or not.

That is, if the influent flow rate (Q) of the backwash sludge is equal to or less than the predetermined reference value, the backwash sludge treatment apparatus 140 is controlled to perform sludge thickening treatment along with fermentation and carbon source recovery. If the influent flow (Q) rate of the backwash sludge exceeding the predetermined reference value is flown in, the control unit (not shown) is controlled so that sludge thickening treatment is performed. For example, the predetermined reference value of the backwash sludge influent flow rate may be 10% of influent flow rate of the sewage and wastewater, in a case where the volume of the second reactor 360 is ⅓ times the volume of the first reactor 350.

Hereinafter, the specific operation method of the backwash sludge treatment apparatus 140 by the control unit (not shown) will be examined.

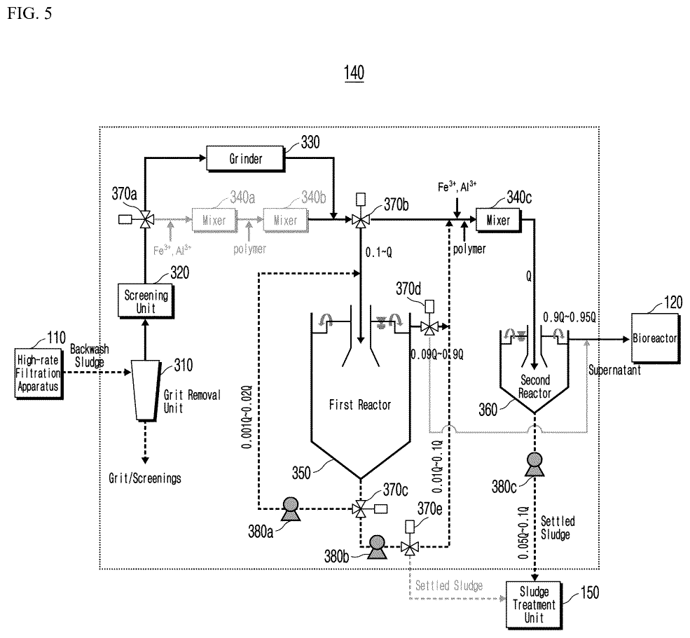

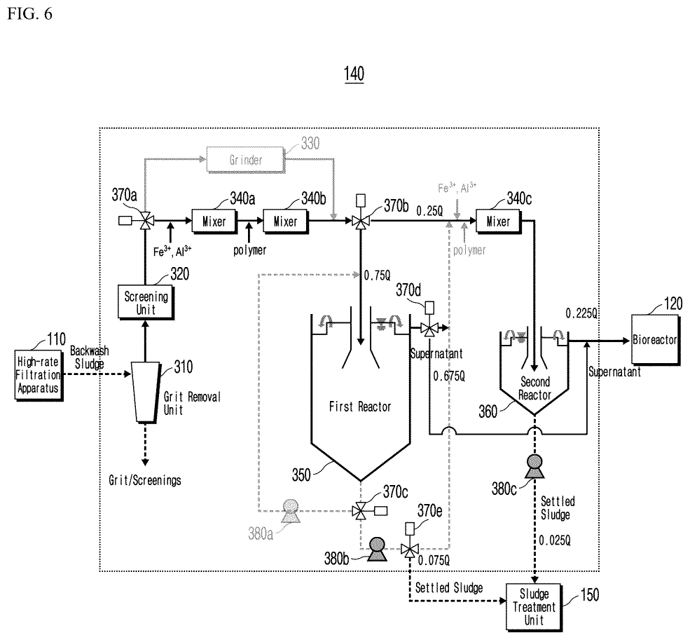

FIGS. 5 and 6 illustrate the operation modes in which a control unit (not shown) controls each component of the backwash sludge treatment apparatus 140 depending on the backwash sludge influent flow rate (Q).

FIG. 5 is a diagram illustrating an operation in which fermentation of backwash sludge and recovery of carbon source (organic acid), and thickening treatment of backwash sludge are performed simultaneously when the influent flow rate (Q) of backwash sludge introduced into the backwash sludge treatment apparatus 140 is less than or equal to a predetermined reference value, according to one embodiment of the present disclosure.

Referring to FIG. 5, when the influent flow rate (Q) of the backwash sludge is equal to or less than the predetermined reference value, the control unit (not shown) controls the flow control valve 370a so that the backwash sludge discharged from the screening unit 320 flows into the grinder 330.

As described above, in the grinder 330, the sludge is ground to improve fermentation efficiency, but no separate chemical dosing is carried out.

The control unit (not shown) controls the flow control valve 370b so that the backwash sludge that has passed through the grinder 330 flows into the first reactor 350 at a ratio of 0.1 to 1.0 of the backwash sludge influent flow rate (Q), and the remainder flows into the second reactor 360.

At this time, the flow rate (0.10 to 1.00) of the backwash sludge supplied to the first reactor 350 may be controlled to secure the retention time required for fermentation and settling by considering the volume of the first reactor 350, and to allow an amount of solids sufficient to generate an adequate organic acids through fermentation is introduced.

The first reactor 350 separates the backwash sludge into a supernatant and settled sludge through solid-liquid separation. The settled sludge is collected in the fermentation/thickening section 430 and undergoes the fermentation reaction while being held for a predetermined retention time.

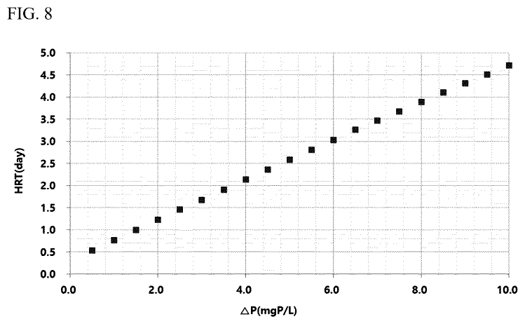

The fermentation process varies depending on the characteristics of the influent solids and the reaction conditions such as temperature, etc., but typically requires a retention time of about 1 to 5 days. In the present disclosure, the predetermined retention time in the first reactor 350 required for the fermentation of sludge may be determined depending on the phosphorus concentration in influent sewage and wastewater and the target phosphorus concentration in treated water. The process of determining the retention time for the first reactor 350 will be described later with reference to FIG. 8.

The predetermined retention time in the first reactor 350 can be controlled by adjusting the influent flow rate of the backwash sludge to the first reactor 350 and the discharge amount of the fermented sludge.

The control unit (not shown) controls the flow control valves 370c and 370e and the sludge discharge pumps 380a and 380b so that the fermented sludge is withdrawn when the fermentation of the settled sludge is completed. At this time, it is preferable that the amount of the fermented sludge withdrawn from the first reactor 350 be in the range of 0.01 to 0.1 times, i.e., 1% to 10%, of the backwash sludge influent flow rate (Q). The fermented sludge withdrawn from the first reactor 350 is transferred to the second reactor 360.

The sludge that has completed the fermentation process in the first reactor 350 contains a high concentration of organic acids. These organic acids deteriorate the settling properties of the fermented sludge while existing in an adsorbed state on the fermented sludge.

Therefore, the fermented sludge transferred to the second reactor 360 undergoes a washing step by being mixed with the supernatant discharged from the first reactor 350 during the transfer process. The organic acids adsorbed on the fermented sludge are separated from the sludge through this washing.

In order to wash the fermented sludge, the control unit (not shown) controls the flow control valve 370d to discharge the supernatant at a flow rate corresponding to a ratio of 0.09 to 0.9 of the backwash sludge influent flow rate (Q), thereby ensuring that is mixed with and washes the fermented sludge.

The fermented sludge mixed with the supernatant is combined with the remaining backwash sludge that did not pass through the first reactor 350 and transferred to the second reactor 360. At this stage, in order to improve the solid-liquid separation characteristics, a coagulant is added upstream of the inlet to the second reactor 360, and the coagulation is performed as the mixture passes through the mixer 340c. Meanwhile, the backwash sludge discharged from the high-rate filtration apparatus 110 is characterized by having a lower solids concentration and a larger volume compared to the primary sludge from the conventional first clarifier.

As described above, the backwash sludge from the high-rate filtration apparatus 110 is generated at a volume of 5 to 15% of the influent sewage and wastewater and has a solid concentration of 1,000 to 5,000 mg/L, which is equivalent to 0.1 to 0.5% of the influent solids concentration.

In the present disclosure, considering the low solid concentration of the backwash sludge flowing into the first reactor 350, a predetermined ratio of the fermented sludge discharged after fermentation is completed in the first reactor 350 is merged with the backwash sludge being introduced into the first reactor. A sufficient amount of fermenting microorganisms can be secured within the first reactor 350 by merging the fermented sludge.

Therefore, the control unit (not shown) drives the flow control valve 370c and the sludge discharge pump 380a to return the fermented sludge from the first reactor 350 to the inlet side of the first reactor 350 in an amount corresponding to 0.001 to 0.02 times the backwash sludge influent flow rate (Q).

The second reactor 360 receives the fermented sludge and supernatant discharged from the first reactor 350, as well as the remaining backwash sludge that has not passed through the first reactor 350, and performs sludge thickening treatment via solid-liquid separation. The total flow rate of the fermented sludge and the supernatant discharged from the first reactor 350, and the sludge introduced into the second reactor 360 without passing through the first reactor 350 is equal to the backwash sludge influent flow rate (Q).

At this time, the fermented sludge and backwash sludge flowing into the second reactor 360 are mixed with a coagulant and passed through a mixer 340c, thereby improving settling characteristics. Subsequently, the sludge and supernatant are separated in the second reactor 360 by gravity sedimentation.

The supernatant, from which solids have been removed and organic acids recovered through solid-liquid separation in the second reactor 360, is transferred to the bioreactor 120 at a flow rate corresponding to 0.9 to 0.95 times the backwash sludge influent flow rate (Q). At this time, since the supernatant is discharged into the bioreactor 120 in a state that the solids are removed, treatment of the backwash sludge is thereby accomplished.

Meanwhile, the sludge collected by sedimentation in the second reactor 360 is generated at a rate corresponding to 0.05 to 0.1 of the influent flow rate (Q), and is discharged to the sludge treatment unit 150 by the sludge discharge pump 380c to perform subsequent sludge treatment.

The sludge, having been treated by fermentation and thickening in the backwash sludge treatment apparatus 140 of the present disclosure, has improved biodegradability while high molecular organic substances are being converted into low molecular-weight organic substances during the fermentation process. As a result, when anaerobic digestion is applied in the sludge treatment unit 150 in the subsequent step, the organic matter decomposition efficiency of the anaerobic digester can be increased.

In addition, the organic acids recovered through the fermentation treatment of the backwash sludge can be usefully employed as an organic carbon source required for the treatment of nitrogen and/or phosphorus in the bioreactor.

Therefore, the backwash sludge treatment apparatus 140 of the present disclosure can recover sufficient organic acids corresponding from the backwash sludge to correspond to the organic matter concentration required for supply to the bioreactor 120, considering the characteristics of the backwash sludge generated from the high-rate filtration apparatus 110. For this purpose, the amount of solids to be fermented and the hydraulic retention time (HRT) for fermentation can be controlled by a control unit (not shown).

FIG. 6 is a diagram illustrating an operation in which thickening treatment of backwash sludge is performed depending on the load of backwash sludge flown in from the backwash sludge treatment apparatus 140 according to one embodiment of the present disclosure.

Depending on the on-site conditions of the wastewater and sewage treatment apparatus 100, there may be cases in which fermentation is not required. In such cases, the backwash sludge treatment apparatus 140 may only perform sludge treatment by settling and thickening, without performing the fermentation treatment of the backwash sludge.

For example, if there is a sudden increase in the influent wastewater flow rate due to events such as rainfall, the flow rate of backwash sludge generated from the high-rate filtration apparatus 110 also increases. In such case, a shorter treatment time is required in response to the increased flow rate of the backwash sludge, and thus the sludge treatment may proceed via thickening.

Referring to FIG. 6, when the influent flow rate (Q) of the backwash sludge exceeds a predetermined reference value, the control unit (not shown) is controlled so that thickening treatment of the backwash sludge in the first and second reactors 350 and 360 are performed by adjusting the flow control valves 370a and 370b.

As described above, the predetermined reference influent flow rate at which the backwash sludge treatment apparatus 140 is controlled to operate only with thickening treatment may be 10% of the sewage and wastewater influent flow rate. Accordingly, when the backwash sludge influent flow rate (Q) exceeds 10% of the sewage and wastewater influent flow rate, the control unit (not shown) is controlled so that the flow control valve 370a is adjusted to add a coagulant to the backwash sludge discharged from the screening unit 320 and then to pass the backwash sludge through the mixers 340a and 340b.

The settleability of the backwash sludge are improved as it passes through the mixers 340a and 340b after addition of the coagulant.

The control unit (not shown) controls the flow control valve 370b so that the backwash sludge mixed with the coagulant is distributed and transferred to the first reactor 350 and the second reactor 360 according to a predetermined ratio.

At this time, the predetermined ratio for distributing the sludge to the first reactor 350 and the second reactor 360 depends on the volume ratio of the reactors. That is, the sludge flow rate distributed to each reactor is adjusted so that the hydraulic retention time (HRT) in the first reactor 350 and the second reactor 360 is identical.

For example, if the volume of the second reactor 360 is ⅓ the volume of the first reactor 350, the flow rate of the backwash sludge distributed to the first reactor 350 and the second reactor 360 by the flow control valve 370b may be controlled to 0.75 times and 0.25 times the backwash sludge influent flow rate (Q), respectively.

In addition, the control unit (not shown) is controlled so that no additional coagulant is added to the backwash sludge flowing into the second reactor 360.

The backwash sludge flown into the first reactor 350 and the second reactor 360 respectively is subjected to solid-liquid separation by gravity sedimentation and separated into settled sludge and a supernatant.

The control unit (not shown) operates the sludge discharge pumps 380b and 380c to discharge the settled sludge from each of the reactors 350 and 360 so that the settled sludge is transferred to the sludge treatment unit 150.

At this time, the settled sludge discharged from each of the reactors 350 and 360 by the sludge discharge pumps 380b and 380c is discharged at a rate corresponding to 10% of the flow rate of the backwash sludge flowing into each of the reactors 350 and 360.

Furthermore, the entire volume of supernatant from the solid-liquid separation in each of the reactors 350 and 360 is returned to the bioreactor 120 so that subsequent treatment is performed in the bioreactor 120.

The backwash sludge treatment apparatus 140 of the present disclosure can select a sludge treatment method in response to fluctuation in the load of incoming sewage and wastewater, and as a result, stable treatment of the sewage and wastewater can be achieved.

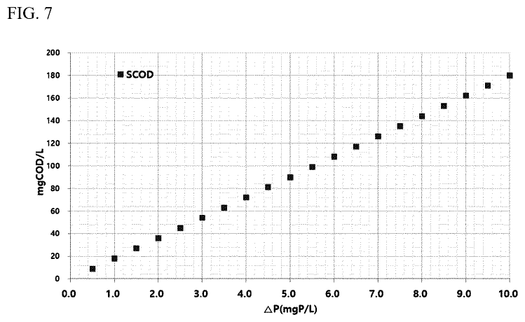

FIG. 7 and FIG. 8 are graphs for explaining the process of deriving the operating conditions for the backwash sludge treatment apparatus 140 required to recover a carbon source (organic acid) through fermentation of sludge in the backwash sludge treatment apparatus 140 according to one embodiment of the present disclosure.

FIG. 7 is a graph illustrating the organic matter concentration required in the bioreactor 120 corresponding to the target phosphorus removal amount for the wastewater and sewage treatment apparatus according to one embodiment of the present disclosure. FIG. 8 is a graph showing the retention time of the backwash sludge in the fermentation/thickening section 430 required to achieve the target phosphorus removal amount in the backwash sludge treatment apparatus 140 according to one embodiment of the present disclosure.

The characteristics of sewage and wastewater flowing into the wastewater and sewage treatment apparatus 100 according to one embodiment of the present disclosure and the characteristics of the backwash sludge generated from the high-rate filtration apparatus 110 are as presented in Table 1.

The high-rate filtration apparatus 110 in the wastewater and sewage treatment apparatus 100 according to one embodiment was operated at a linear velocity (LV) of 8.1 m/hr, and backwashing of the high-rate filtration apparatus was performed at a cycle of 4 hours. In the case of the above embodiment, the high-rate filtration apparatus 110 exhibited a 70% removal efficiency for suspended solids (SS).

In addition, for the influent characteristics presented in Table 1, the backwash sludge generated through the operation of the high-rate filtration apparatus 110 under the aforementioned operating conditions was generated at a level equivalent 8% of the influent flow rate of the sewage and wastewater to the treatment apparatus 100, and was subsequently introduced into the backwash sludge treatment apparatus 140.

TABLE 1

| | TCOD | SCOD | TSS | VSS |
|---|---|---|---|---|
| | (mg/L) | (mg/L) | (mg/L) | (mg/L) |
| influentsewage | 749 | 51 | 291 | 218 |
| and wastewater | | | | |
| Backwash | 3,900 | 351 | 2,600 | 1,950 |
| sludge | | | | |

As mentioned above, the concentration of dissolved organic matter such as organic acids is very important for the removal of phosphorus (P) in the bioreactor 120. According to the results of previous studies, the concentration of biodegradable organic matter required for phosphorus (P) removal may vary depending on the operating conditions, but it is known that at least 18 to 20 mgCOD/APmg of organic matter is required to treat phosphorus (P) in the effluent to 1.0 mg/L or less.

Considering that the concentration of phosphorus (P) in sewage and wastewater is typically in the range of 5 to 10 mg/L, a concentration of dissolved organic matter of at least 80 to 180 mg/L should be maintained within the bioreactor 120 in order to maintain the concentration of phosphorus (P) in the final effluent to 1.0 mg/L or less. Referring to FIG. 7, the concentration of organic matter required for the removal of unit weight of phosphorus is set based on 18 mgCOD/APmg (the slope of the linear relationship in FIG. 8). When the concentration of phosphorus (P) in the influent to the wastewater sewage and treatment apparatus 100 of the embodiment is 5.0 mg/L, and the target concentration in treated water is 1.0 mg/L (target phosphorus removal amount of 4 mg/L), the concentration of organic matter required in wastewater sewage and treatment apparatus 100 becomes 72 mg/L.

Referring to FIG. 8, when the target phosphorous removal amount is 4 mg/L, the retention time (HRT) that the backwash sludge needs to be retained in the fermentation/thickening section 430 of the first reactor 350 of the present disclosure for fermentation can be calculated to be 2.1 days.

On this wise, based on the required organic matter concentration and the retention time (HRT) for sludge treatment, the backwash sludge influent flow rate, hydraulic retention time, sludge discharge ratio, etc. of each of the reactors 350 and 370 in the backwash sludge treatment apparatus 140 can be determined.

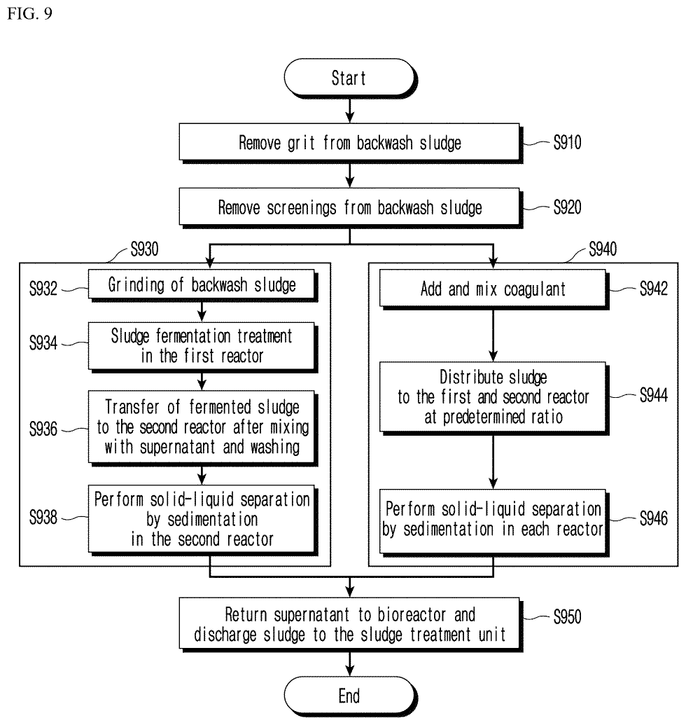

FIG. 9 is a flow chart illustrating a method for treating backwash sludge within the wastewater sewage and treatment apparatus 100 according to one embodiment of the present disclosure.

Grit is removed from backwash sludge (S910).

Grit is primarily removed from the backwash sludge generated through the backwash process of the high-rate filtration apparatus 110.

Since grit materials have a relatively high specific gravity, they may be removed by a separation method based on the difference in specific gravity, and for example, they may be separated from the backwash sludge by centrifugal force using a cyclone method.

Screenings are removed from the backwash sludge from which the grit materials have been removed (S920).

Screenings are secondarily removed from the backwash sludge from which the grit materials have been removed. At this time, the screenings may be removed using a screen.

Unlike a gravity-based sedimentation tank, the high-rate filtration apparatus 110 removes grit and screenings as solids together in the filtration process using a filter media. Therefore, the backwash sludge contains grit and screenings with poor settleability. Since such grit and screenings may reduce the efficiency when performing the fermentation treatment and/or sedimentation/thickening treatment of the backwash sludge performed in the subsequent step, they should be removed as a pretreatment at the inlet stage of the backwash sludge.

Control is performed so that the backwash sludge treatment method is changed by determining whether the influent flow rate (Q) of the backwash sludge exceeds the predetermined reference flow rate or not.

The fermentation treatment of the sludge is performed if the influent flow rate of the backwash sludge is equal to or less than the predetermined reference flow rate (S930).

The fermentation treatment of the sludge (S930) includes a step of grinding the backwash sludge from which the screenings have been removed (S932), a step of performing gravity sedimentation and fermentation treatment on the ground sludge in the first reactor 350 (S934), a step of withdrawing the fermented sludge from the first reactor 350 and transferring it to the second reactor 360 (S936), and a step of performing solid-liquid separation on the fermented sludge in the second reactor by a gravity sedimentation (S938).

Furthermore, thickening treatment of the sludge is performed if the influent flow rate of the backwash sludge exceeds the predetermined reference flow rate (S940).

The thickening treatment of the backwash sludge (S940) includes a step of adding a coagulant to the backwash sludge from which the screenings have been removed and mixing it to improve the settleability (S942), a step of distributing and supplying the backwash sludge to the first reactor 350 and the second reactor 360 according to a predetermined ratio (S944), and a step of performing solid-liquid separation on the backwash sludge flown-in from each of the reactors 350 and 360 (S946).

In the fermentation treatment step (S930) or the thickening treatment step (S940) of the backwash sludge, the supernatant that has been subjected to the solid-liquid separation is discharged to the bioreactor 120, and the separated settled sludge is discharged to the sludge treatment unit 150, respectively (S950).

Although the respective processes are described as being executed sequentially in FIG. 9, this is only an example of explaining the technical idea of one embodiment of the present disclosure. In other words, since those skilled in the art to which one embodiment of the present disclosure pertains may change and execute the order of the processes described in the respective diagrams without departing from the essential characteristics of one embodiment of the present disclosure, or can be applied by modifying and transforming the processes in various ways by executing one or more processes among the processes in parallel, FIG. 9 is not limited to a chronological order.

Meanwhile, the processes shown in FIG. 9 can be implemented as computer-readable codes on a computer-readable recording medium. The computer-readable recording medium includes all types of recording devices that store data that can be read by a computer system. That is, the computer-readable recording medium includes storage media such as magnetic storage media (e.g., ROM, floppy disk, hard disk, etc.), optical reading media (e.g., CD-ROM, DVD, etc.), and carrier waves (e.g., transmission via the Internet). In addition, the computer-readable recording medium can be distributed to computer systems connected through a network, so that the computer-readable codes can be stored and executed in a distributed manner.

The above description is merely an illustrative explanation of the technical idea of this embodiment, and those skilled in the art to which this embodiment pertains will be able to make various modifications and variations without departing from the essential characteristics of this embodiment. Accordingly, these embodiments are not intended to limit the technical idea of this embodiment, but rather to explain it, and the scope of the technical idea of this embodiment is not limited by such an embodiment. The scope of protection of this embodiment should be interpreted in accordance with the claims below, and all technical ideas within the scope equivalent thereto should be interpreted as being included in the scope of rights of this embodiment.

### CROSS-REFERENCE TO RELATED APPLICATION

This application claims priority under 35 U.S.C. § 119(a) to Korean Patent application No. 10-2023-0043468, filed in the Korean Intellectual Property Office on Apr. 3, 2023, the entire contents of which are incorporated herein by reference. In addition, if this patent application claims priority in a country other than the United States for the same reasons as above, all contents thereof are incorporated by reference into this patent application.

1. An apparatus for treating backwash sludge from a high-rate filtration process, the apparatus comprising:
a pretreatment unit for removing grit and screenings from the backwash sludge;
a first reactor configured to settle, thicken, and ferment the backwash sludge that has passed through the pretreatment unit;
a second reactor configured to receive sludge discharged from the first reactor and/or the backwash sludge that has passed through the pretreatment unit, and separate it into settled sludge and supernatant via sedimentation; and
a control unit configured to control an operation of each component within the backwash sludge treatment apparatus.

2. The apparatus of claim 1, wherein the control unit is configured to, when an influent flow rate to the backwash sludge treatment apparatus is maintained at or below a predetermined reference flow rate, supply fermented sludge, which has been settled, thickened, and fermented in the first reactor, to the second reactor to perform solid-liquid separation.

3. The apparatus of claim 2, wherein the control unit is configured to recirculate a predetermined ratio of the fermented sludge discharged from the first reactor to an inlet side of the first reactor to merge with the incoming backwash sludge.

4. The apparatus of claim 2, wherein the control unit is configured such that the fermented sludge transferred to the second reactor is mixed with the supernatant discharged from the first reactor so that organic acids in the fermented sludge are washed before being introduced into the second reactor.

5. The apparatus of claim 4, wherein the mixture of the fermented sludge and the supernatant is introduced into the second reactor after a coagulant is added thereto.

6. The apparatus of claim 2, wherein the control unit is configured to control a concentration of organic matter recovered from the fermented sludge by adjusting one or more of: a ratio of the flow rate of the backwash sludge that has passed through the pretreatment unit distributed to the first reactor and the second reactor, solid retention time (SRT) during which the sludge is retained in the first reactor, or a discharge flow rate of the fermented sludge that has completed the fermentation process in the first reactor and is discharged to the second reactor.

7. The apparatus of claim 1, wherein the control unit is configured such that, when an influent flow rate into the backwash sludge treatment apparatus exceeds a predetermined reference flow rate, the backwash sludge having passed through the pretreatment unit is distributed to the first and the second reactors at a predetermined ratio, and solid-liquid separation through settling and thickening of the sludge is performed in each reactor.

8. The apparatus of claim 7, wherein the control unit is configured such that, when the influent flow rate to the backwash sludge treatment apparatus exceeds the predetermined reference flow rate, a coagulant is added to the backwash sludge having passed through the pretreatment unit prior to distribution to the reactors.

9. The apparatus of claim 7, wherein the control unit is configured to control the predetermined ratio at which the backwash sludge is distributed to each of the reactors so that hydraulic retention times of the backwash sludge in the first and second reactors is maintained the same.

10. A method for treating backwash sludge of a high-rate filtration process, the method comprising steps of:
removing grit and screenings from backwash sludge;
determining whether an influent flow rate of the backwash sludge exceeds a predetermined reference flow rate;
if the influent flow rate is at or below the predetermined reference flow rate, settling, thickening, and fermenting the backwash sludge from which the grit and screenings have been removed; and
performing solid-liquid separation on the fermented backwash sludge via sedimentation.

11. The method of claim 10, further comprising the step of:
when the influent flow rate of the backwash sludge exceeds the predetermined reference flow rate, adding a coagulant to the backwash sludge from which the grit and screenings have been removed, and performing solid-liquid separation by settling and thickening the backwash sludge by gravity sedimentation.
